(19) United States
(12) Patent Application Publication
(10) Pub. No.: US 2016/0165699 A1
(43) Pub. Date: Jun. 9, 2016

(54) LIGHTING DEVICE CONTROL SYSTEM FOR LIGHT ADAPTATION

(71) Applicant: IDSYS.,CO,LTD, Seoul (KR)

(72) Inventor: Yoeng Cheol YOON, Gyeonggi-do (KR)

(73) Assignee: IDSYS.,CO,LTD, Seoul (KR)

(21) Appl. No.: 14/907,822

(22) PCT Filed: Oct. 21, 2013
(86) PCT No.: PCT/KR2013/009371

§ 371 Date: Jan. 27, 2016

(30) Foreign Application Priority Data
Sep. 3, 2013 (KR) 10-2013-0105455

(51) Int. Cl. H05B 37/02

(52) U.S. Cl. CPC H05B 37/0218; H05B 37/0245

(57) ABSTRACT

The invention relates to a control system. In particular, the invention has an object to provide a lighting device control system for controlling a lighting device upon receiving a turn-on signal to turn on the lighting device, to emit light capable of generating an illuminance equal to or lower than an ambient illuminance around a place where the lighting device is installed.

### TECHNICAL FIELD

The present invention relates to an illumination control system, and more particularly to a light adaptation lighting device control system for controlling a lighting device configured to allow a person to easily adapt to brightness.

### BACKGROUND ART

Lighting devices are installed in various spaces of the interior of an office, a hallway, a stairway, an entrance, a living room, a bedroom, and the like.

Conventional lighting devices are configured to be simply turned on or off by a switch.

However, recently developed lighting devices are provided with a sensor capable of sensing movement of the user or the like, for the purpose of achieving energy savings, etc. Such a lighting device has functions of turning on upon sensing movement of the user, and turning off when no movement is sensed.

However, a non-lighting state, namely, a dark state, is kept until the sensor of the lighting device senses the user because the lighting device is turned on or off in accordance with whether or not the user is sensed.

In order to solve the above-mentioned problem, Korean Registered Patent Publication No. 10-0928455 discloses a lighting device capable of continuously emitting light of a certain brightness even when no user is sensed.

In the disclosed lighting device, a lamp is driven at maximum brightness upon receiving a user sensing signal from a sensor. After the lamp reaches a maximum brightness, a timer is controlled to perform a counting operation and, as such, brightness of the lamp is reduced to a level corresponding to an illuminance equal to or less than a predetermined dark adaptation threshold value whenever a counting signal is generated from the timer. When the brightness of the lamp reaches a predetermined reference brightness, the timer is controlled to no longer perform a counting operation and, as such, the lamp maintains the predetermined reference brightness.

However, the above-mentioned conventional lighting device may cause inconvenience of the user because the brightness of the lighting device is gradually reduced to the predetermined brightness after turning on at a maximum brightness upon sensing the user.

That is, when the user moves from one place to another place in an indoor space where the conventional lighting device is installed, the lighting device abruptly brightens and, as such, the user who has been located at a dark place having a lower brightness than the brightness of the lighting device may feel inconvenienced.

In brief, the eyes of the user feel uncomfortable when abruptly exposed to a place having a higher brightness than a previous place where the user has been located and, as such, are stressed. However, the above-mentioned conventional lighting devices cannot solve such inconvenience and stress.

### DISCLOSURE

### Technical Problem

Therefore, the present invention has been made in view of the above problems, and it is an object of the present invention to provide a lighting device control system capable of controlling a lighting device to generate light capable of generating an illuminance equal to or lower than an ambient illuminance around a place where the lighting device is installed, upon receiving a turn-on signal for turning on the lighting device.

### Technical Solution

In accordance with an aspect of the present invention, the above and other objects can be accomplished by the provision of a lighting device control system including a first lighting device installed in a first space, to emit light, a first switch for receiving a user control signal for control of brightness of the first lighting device, a first illuminance sensor installed in the first space, to detect a first illuminance of the first space, a second lighting device installed in a second space, to emit light, a second switch for receiving a user control signal for control of brightness of the second lighting device, a second illuminance sensor installed in the second space, to detect a second illuminance of the second space, and a spatial illuminance controller storing a look-up table in which relations among illuminance, start brightness, and target brightness are set, and receiving the first illuminance and the second illuminance, the spatial illuminance controller sending, to the second lighting device, a controller control signal to turn on the second lighting device at a start brightness corresponding to the first illuminance while being stored in the look-up table, upon receiving a turn-on signal from the second switch in accordance with movement of an object from the first space to the second space, and sending, to the second lighting device, a controller control signal to increase a brightness of the second lighting device to a target brightness corresponding to the first illuminance while being stored in the look-up table, wherein the controller control signal selects, as the start brightness, a brightness to generate an illuminance higher than a minimum illuminance that the second lighting device can generate, but equal to or lower than the first illuminance, and selects, as the target brightness, a brightness to generate an illuminance higher than the first illuminance, but equal to or lower than a maximum illuminance that the second lighting device can generate.

### Advantageous Effects

In the present invention, it may be possible to reduce eye fatigue of the user because the brightness of the lighting device is gradually increased in accordance with an ambient illuminance.

### DESCRIPTION OF DRAWINGS

The above and other objects, features and other advantages of the present invention will be more clearly understood from the following detailed description taken in conjunction with the accompanying drawings, in which:

FIG. 1 is a schematic view illustrating an indoor space to which a lighting device control system according to the present invention is applied;

FIG. 2 is a block diagram illustrating a configuration of a spatial illuminance controller applied to the lighting device control system according to the present invention; and

FIG. 3 is a diagram illustrating a method for controlling brightnesses of lighting devices, using the lighting device control system according to the present invention.

### BEST MODE

Hereinafter, embodiments of the present invention will be described in detail with reference to the accompanying drawings.

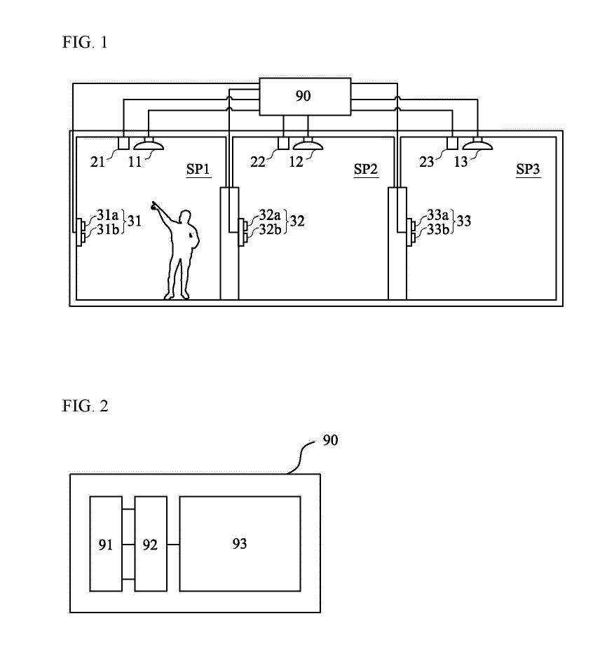

FIG. 1 is a schematic view illustrating an indoor space to which a lighting device control system according to the present invention is applied. FIG. 2 is a block diagram illustrating a configuration of a spatial illuminance controller applied to the lighting device control system according to the present invention. For convenience of description, the present invention will be described in conjunction with an example in which a first lighting device 11 and a second lighting device 12 are installed in a first space SP1 and a second space SP2, respectively. If necessary, the present invention will be described under the condition that a third lighting device 13 installed in a third space SP3 is added. In addition, the lighting device control system according to the present invention, which will be described hereinafter, may be applied to the case in which lighting devices are installed in four or more spaces, respectively, in the same manner as that of the above-described case.

As illustrated in FIG. 1, the lighting device control system according to the present invention includes the first lighting device 11, which is installed in the first space SP1, to emit light, a first switch 31 for receiving a user control signal for control of brightness of the first lighting device 11, and a first illuminance sensor 21 installed in the first space SP1, to detect a first illuminance of the first space SP1. The lighting device control system also includes the second lighting device 12, which is installed in the second space SP2, to emit light, a second switch 32 for receiving a user control signal for control of brightness of the second lighting device 12, and a second illuminance sensor 22 installed in the second space SP2, to detect a second illuminance of the second space SP2. The lighting device control system further includes a spatial illuminance controller 90 for sending, to the first lighting device 11, a controller control signal to turn on the first lighting device 11 at a start brightness generating an illuminance equal to or lower than the first illuminance, and then to increase the brightness of the first lighting device 11 to a target brightness lower than a maximum brightness, upon receiving a turn-on signal from the first switch 31. In this case, the spatial illuminance controller 90 stores a look-up table in which relations among illuminance, start brightness, and target brightness are set. The spatial illuminance controller 90 receives the first illuminance and second illuminance. Upon receiving a turn-on signal from the second switch 32, the spatial illuminance controller 90 sends, to the second lighting device 12, a controller control signal to turn on the second lighting device 12 at a start brightness corresponding to the first illuminance while being stored in the look-up table, and then sends, to the second lighting device 12, a controller control signal to increase the brightness of the second lighting device 12 to a target brightness corresponding to the first illuminance while being stored in the look-up table.

As the first lighting device 11 and second lighting device 12, any kinds of brightness-adjustable lighting devices may be used. For example, as the first lighting device 11 and second lighting device 12, an incandescent electric lamp, fluorescent lamp, a halogen lamp, a light emitting diode (LED) or the like, which is adjustable in brightness, may be used. In the following description, brightness of the first lighting device 11 and second lighting device 12 may be defined by luminance.

The first switch 31 and second switch 32 are adapted to receive a turn-on signal, a turn-off signal, or a user control signal from the user. The first switch 31 and second switch 32 may be configured by various kinds of buttons or the like.

In particular, the first switch 31 includes a first main switch 31a for turning on the first lighting device 11 or sending, to the spatial illuminance controller 90, a turn-on signal to supply electric power to the first lighting device 11 for driving of the first lighting device 11, upon receiving the turn-on signal, while cutting off supply of the electric power to the first lighting device 11 upon receiving a turn-off signal, and a first sub-switch 31b for receiving a user control signal to increase or decrease the brightness of the first lighting device 11, and sending, to the spatial illuminance controller 90, a lighting device control signal corresponding to the user control signal.

That is, the first main switch 31a may only execute a function of simply turning on the first lighting device 11 at a predetermined brightness or simply turning off the first lighting device 11. In addition, the first main switch 31a may be applied to a lighting control function, which will be described later. That is, when the first main switch 31a turns on from an OFF state, the spatial illuminance controller 90 may set the start brightness and target brightness of the first lighting device 11, based on the first illuminance.

Meanwhile, the second switch 32 includes a second main switch 32a for turning on the second lighting device 12 or sending, to the spatial illuminance controller 90, a turn-on signal to supply electric power to the second lighting device 12 for driving of the second lighting device 12, upon receiving the turn-on signal, while cutting off supply of the electric power to the second lighting device 12 upon receiving a turn-off signal, and a second sub-switch 32b for receiving a user control signal to increase or decrease the brightness of the second lighting device 12, and sending, to the spatial illuminance controller 90, a lighting device control signal corresponding to the user control signal.

That is, the second main switch 32a may only execute a function of simply turning on the second lighting device 12 at a predetermined brightness or simply turning off the second lighting device 12. In addition, the second main switch 32a may be applied to a lighting control function, which will be described later. That is, when the second main switch 32a turns on from an OFF state, the spatial illuminance controller 90 may set the start brightness and target brightness of the second lighting device 12, based on the second illuminance.

The first illuminance sensor 21 is installed in the first space SP1, to execute a function of detecting the illuminance of the first space SP1. The second illuminance sensor 22 is installed in the second space SP2, to execute a function of detecting the illuminance of the second space SP2. As the first illuminance sensor 21 and second illuminance sensor 22, the existing illuminance sensor used for detection of illuminance may be used.

The first illuminance sensor 21 and second illuminance sensor 22 may be mounted to the first lighting device 11 and second lighting device 12, respectively. Alternatively, the first illuminance sensor 21 and second illuminance sensor 22 may be configured independently of the first lighting device 11 and second lighting device 12. In this case, each of the first illuminance sensor 21 and second illuminance sensor 22 may be mounted to a ceiling or wall of the associated space.

Finally, the spatial illuminance controller 90 executes a function of controlling brightnesses of the first lighting device 11 and second lighting device 12.

In a first example, upon receiving a turn-on signal from the first switch 31, the spatial illuminance controller 90 executes a function of sending, to the first lighting device 11, a controller control signal to turn on the first lighting device 11 at a start brightness equal to or lower than a brightness to generate the first illuminance, and then to increase the brightness of the first lighting device 11 to a target brightness lower than a maximum brightness of the first lighting device 11.

Here, the start brightness means the brightness of light initially emitted from the first lighting device 11 during driving of the first lighting device 11. The target brightness means the brightness of the first lighting device 11 finally obtained as the first lighting device 11 gradually brightens from the start brightness.

That is, the start brightness is the brightness of the first lighting device 11 at a time when the first lighting device 11 starts to emit light. The start brightness may be set to a brightness to generate an illuminance equal to or lower than the first illuminance.

The target brightness means the brightness of the first lighting device 11 finally obtained when no separate control signal is input to the first lighting device 11, except for the turn-on signal.

The target brightness may be set to a brightness to generate an illuminance lower than a maximum illuminance that can be generated by the first lighting device 11.

In a second example, upon receiving a lighting device control signal to increase or decrease brightness of the first lighting device 11 from the first switch 31 in a state in which the first lighting device 11 is driven at the target brightness, the spatial illuminance controller 90 may execute a function of sending, to the first lighting device 11, a controller control signal to control the first lighting device 11 to generate a brightness corresponding to a controlled brightness within a range between minimum and maximum brightnesses of the first lighting device 11.

That is, the target brightness is set to be lower than the maximum brightness of the first lighting device 11. Accordingly, when the user desires a brightness higher than the target brightness, but equal to or lower than the maximum brightness, the user raises a level of the first sub-switch 31b of the first switch 31. In this case, the spatial illuminance controller 90 may increase the brightness of the first lighting device 11.

On the other hand, when the user desires a brightness lower than the target brightness, but equal to or higher than the minimum brightness, the user lowers the level of the first sub-switch 31b of the first switch 31. In this case, the spatial illuminance controller 90 may decrease the brightness of the first lighting device 11.

Here, the maximum brightness means a maximum luminance that the first lighting device 11 can generate. The maximum brightness depends on characteristics of the first lighting device 11.

However, the minimum brightness may be set to have various values by the manufacturer. That is, the minimum brightness may be set to correspond to a brightness when the first lighting device 11 turns off (in this case, the minimum brightness is “0”). Otherwise, the minimum brightness may be set to be higher than the brightness of the first lighting device 11 in the case in which the first lighting device 11 turns off, but lower than the maximum brightness.

In addition, the controlled brightness means a brightness controlled by the user. That is, the user may vary the brightness of the first lighting device 11, which generates the target brightness, to the controlled brightness. The controlled brightness may be higher or lower than the target brightness.

That is, when the user determines that the target brightness is excessively high, the user lowers the level of the first sub-switch 31b. Upon receiving the resultant lighting device control signal sent from the first sub-switch 31b, the spatial illuminance controller 90 may send, to the first lighting device 11, a controller control signal to control the first lighting device 11 to generate a brightness corresponding to a controlled brightness lower than the target brightness.

On the other hand, when the user determines that the target brightness is excessively low, the user raises the level of the first sub-switch 31b. Upon receiving the resultant lighting device control signal sent from the first sub-switch 31b, the spatial illuminance controller 90 may send, to the first lighting device 11, a controller control signal to control the first lighting device 11 to generate a brightness corresponding to a controlled brightness higher than the target brightness.

Meanwhile, definitions of the start brightness, target brightness, maximum brightness, minimum brightness, and controlled brightness applied to the first lighting device 11 are applied to the second lighting device 12, third lighting device 13, and other lighting devices installed in other spaces in the same manner as described above.

In a third example, upon receiving a turn-on signal from the second switch 32, the spatial illuminance controller 90 may send, to the second lighting device 12, a controller control signal to turn on the second lighting device 12 at a start brightness corresponding to the first illuminance, and may then send, to the second lighting device 12, a controller control signal to increase the brightness of the second lighting device 12 to a target brightness lower than the maximum brightness of the second lighting device 12.

Here, the start brightness corresponding to the first illuminance means a brightness equal to or lower than the brightness corresponding to the first illuminance.

In detail, the spatial illuminance controller 90 stores a look-up table in which relations among illuminance, start brightness, and target brightness are set. The spatial illuminance controller 90 receives the first illuminance and second illuminance. Upon receiving a turn-on signal from the second switch 32, the spatial illuminance controller 90 sends, to the second lighting device 12, a controller control signal to turn on the second lighting device 12 at a start brightness corresponding to the first illuminance while being stored in the look-up table, and then sends, to the second lighting device 12, a controller control signal to increase the brightness of the second lighting device 12 to a target brightness corresponding to the first illuminance while being stored in the look-up table.

The controller control signal may select, as the start brightness, an illuminance higher than the minimum illuminance that the second lighting device 12 can generate, but equal to or lower than the first illuminance. The controller control signal may also select, as the target brightness, a brightness to generate an illuminance higher than the first illuminance, but lower than the maximum illuminance that the second lighting device 12 can generate.

In a fourth example, upon receiving a lighting device control signal to increase or decrease brightness of the second lighting device 12 from the second switch 32, the spatial illuminance controller 90 may send, to the second lighting device 12, a controller control signal to control the second lighting device 12 to generate a brightness within a range between minimum and maximum brightnesses of the second lighting device 12.

Meanwhile, in order to execute the above-described functions, as illustrated in FIG. 2, the spatial illuminance controller 90 includes a communication unit 91 for executing communication with the lighting devices, the illuminance sensor, and the switches, a storage unit 93 for storing the look-up table containing information for controlling brightnesses of the lighting devices, and a controller 92 for controlling brightnesses of the lighting devices, using information received from the illuminance sensors and the look-up table.

In this case, the storage unit 93 may store a look-up table as depicted in the following Table 1. That is, the look-up table depicted in the following Table 1 is a table representing relations between illuminances received from respective illumination sensors and brightnesses of respective lighting devices.

The illuminances defined in Table 1 are set to have various levels by the manufacturer of the spatial illuminance controller 90. Such illuminances may be calculated in accordance with the following principle.

That is, the maximum illuminance max that each illuminance sensor can measure in accordance with characteristics thereof may be numerically defined. For example, in the case of an illuminance sensor having a resolution of 10 bits (measurement range: 0 to 1,023), the maximum illuminance thereof is 1,023.

In this case, when the value of illuminance practically measured in a specific space is about 512, it may be considered that the illuminance of the space is 50%.

In addition, when the measured value of the illuminance sensor is 0, the illuminance of the space is considered to be 0% (very dark state). When the measured value is 1,023, the illuminance of the space is considered to be 100% (very bright state). That is, each percentage in Table 1 means a percentage of the current illuminance with reference to the maximum illuminance.

TABLE 1

| Currently Measured | Target Brightness According to |
|---|---|
| Illuminance of Space | Turn-on of Main Switch |
| 0 to 30% | 40 to 80% |
| 31 to 60% | 80 to 90% |
| 61 to 100% | 90 to 100% |

Referring to the look-up table depicted in Table 1, in the case in which the first space SP1 is a current illuminance measurement space, the controller 92 controls the first lighting device 11 to turn on at a start brightness corresponding to 0 to 30% of a maximum brightness when the first illuminance measured in the first space SP1 is 0 to 30% of a maximum illuminance, and then to brighten to a target brightness corresponding to 40 to 80% of a maximum brightness.

Here, the maximum illuminance means a maximum illuminance measureable in the first space SP1. The user may set the maximum illuminance to have various values, referring to illuminances measured for various lighting devices.

In accordance with the same method as described above, the controller 92 controls the first lighting device 11 to turn on at a start brightness corresponding to 61 to 100% of the maximum brightness when the first illuminance measured in the first space SP1 is 61 to 100% of a maximum illuminance, and then to brighten to a target brightness corresponding to 90 to 100% of the maximum brightness.

That is, in accordance with the present invention, the start brightness of each lighting device corresponds to a brightness capable of generating an illuminance equal to or lower than the illuminance measured by the associated illuminance sensor. On the other hand, the target brightness of each lighting device corresponds to a brightness capable of generating an illuminance higher than the measured illuminance.

Although the target brightness may be equal to the maximum brightness of the lighting device, the target brightness may be set to be lower than the maximum brightness, to allow the user to select a desired target brightness.

That is, the measured illuminance may be associated with a space other than the space where the lighting device is installed. In this case, the brightness of the lighting device, which is installed in a space other than the space associated with the measured illuminance, may not correspond to the same illuminance as the measured illuminance.

For example, when the main switch 32a of the second switch 32 turns on in accordance with movement of the user from the first space SP1 to the second space SP2 under the condition that the first illuminance measured in the first space SP1 is 80% of the maximum illuminance, the controller 92 sends, to the second lighting device 12, a controller control signal to turn on the second lighting device 12 at a start brightness capable of generating an illuminance lower than the maximum illuminance.

Thereafter, the controller 92 may send, to the second lighting device 12, a controller control signal to control the second lighting device 12 to generate a target brightness higher than the start brightness, but lower than the maximum brightness thereof.

In Table 1, the illuminance capable of determining the start brightness and target brightness of each lighting device is divided into three levels. However, the illuminance may be divided into four or more levels. Alternatively, the illuminance may be divided into two levels.

Hereinafter, a method for controlling brightnesses of the lighting devices, using a lighting device control system according to the present invention, will be described with reference to FIGS. 1 to 3 and the above-described examples.

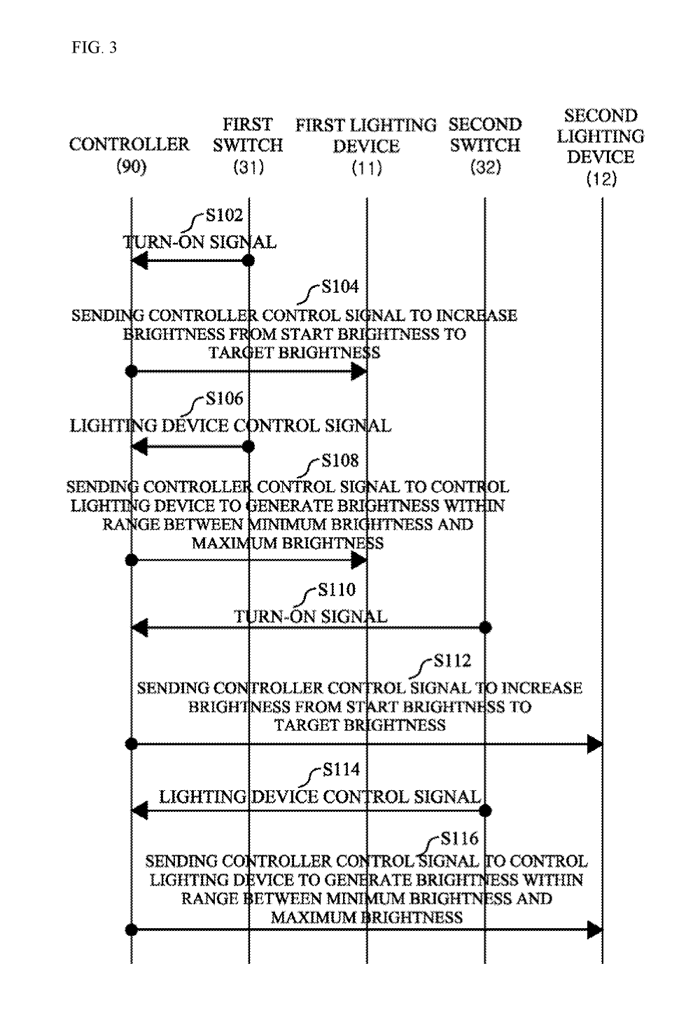

FIG. 3 is a diagram illustrating the method for controlling brightnesses of the lighting devices, using the lighting device control system according to the present invention.

First, the method for controlling brightnesses of the lighting devices will be described in conjunction with the above-described first example. The first example is a method for controlling brightness of the first lighting device 11 by the first illumination sensor 21 installed in the first space SP1.

First, the user who has entered the first space SP1 turns on the first main switch 31a of the first switch 31 or the first sub-switch 31b of the first switch 31. Then, the first switch 31 sends a turn-on signal to the spatial illuminance controller 90 (S102).

Second, upon receiving the turn-on signal from the first switch 31, the spatial illuminance controller 90 sends, to the first lighting device 11, a controller control signal to turn on the first lighting device 11 at a start brightness generating an illuminance equal to or lower than the first illuminance, and then to increase the brightness of the first lighting device 11 to a target brightness lower than a maximum brightness (S104).

In this case, when the first illuminance is within the illuminance range of 0 to 30% in Table 1, the spatial illuminance controller 90 sends, to the first lighting device 11, a controller control signal to set the start brightness to a brightness within a brightness range of 0 to 30% while setting the target brightness to a brightness within a brightness range of 40 to 50%.

Meanwhile, when the first illuminance is within the illuminance range of 60 to 100% in Table 1, the spatial illuminance controller 90 sends, to the first lighting device 11, a controller control signal to set the start brightness to a brightness within a brightness range of 60 to 100% while setting the target brightness to a brightness within a brightness range of 90 to 100%. In this case, the start brightness is set to a brightness capable of generating an illuminance equal to or lower than the first illuminance, and the target brightness is set to a brightness capable of generating an illuminance higher than the illuminance corresponding to the start brightness.

Third, in accordance with the controller control signal, the lighting device 11 turns on at the start brightness, and then generally increases the brightness thereof, to reach the target brightness.

Next, the method for controlling brightnesses of the lighting devices will be described in conjunction with the above-described second example. The method of the second example is a method for controlling brightness of the first lighting device 11 when the user desires to vary the target brightness under the condition that the first lighting device 11 generates the target brightness after turning on at the start brightness in accordance with the method of the first example.

First, the user who is located in the first space SP1 raises or lowers a level of the first sub-switch 31b of the first switch 31. The first sub-switch 31b sends a lighting device control signal generated in accordance with the above-described operation to the spatial illuminance controller 90 (S106). In the following description, the present invention will be described in conjunction with an example in which the level of the first sub-switch 31b is raised, for convenience of description. The following description may also be applied to the case in which the level of the first sub-switch 31b is lowered.

Here, rising of the level of the first sub-switch 31b means an increase in brightness of the first lighting device 11. On the other hand, lowering of the level of the first sub-switch 31b means a decrease in brightness of the first lighting device 11.

Second, upon receiving a lighting device control signal to increase brightness of the first lighting device 11 from the first switch 31 under the condition that the first lighting device 11 is driven at the target brightness thereof, the spatial illuminance controller 90 sends, to the first lighting device 11, a controller control signal to control the first lighting device 11 to generate a controlled brightness higher than the target brightness of the first lighting device 11, but equal to or lower than the maximum brightness (S108).

In this case, when the target brightness of the first lighting device 11 corresponds to 40 to 50% of the maximum brightness, the spatial illuminance controller 90 sends, to the first lighting device 11, a controller control signal to set the controlled brightness to 40 to 70% of the maximum brightness.

In addition, when the target brightness of the first lighting device 11 is set to be 60 to 100% of the maximum brightness, the spatial illuminance controller 90 sends, to the first lighting device 11, a controller control signal to set the controlled brightness to 90 to 100% of the maximum brightness.

In this case, the controlled brightness is set to be higher than the target brightness.

That is, when the target brightness is 45%, the controlled brightness may be set to 50%. When the target brightness is 90%, the controlled brightness may be set to 95%. Setting of the controlled brightness is achieved through the look-up table stored in the storage unit 93.

Third, in accordance with the controller control signal, the first lighting device 11 gradually increases the brightness of the first lighting device 11 in order to enable the first lighting device 11 to reach the controlled brightness.

Next, the method for controlling brightnesses of the lighting devices will be described in conjunction with the above-described third example. The method of the third example is a method for controlling brightness of the second lighting device 12 when the user who has been located in the first space SP1 turns on the second lighting device 12 installed in the second space SP2 after moving to the second space SP2 under the condition that the first lighting device 11 installed in the first space SP1 is driven at the target brightness or controlled brightness thereof.

First, the user who has entered the second space SP2 turns on the second main switch 32a of the second switch 32. Then, the second main switch 32a sends a turn-on signal to the spatial illuminance controller 90 (S110).

Second, upon receiving the turn-on signal from the second switch 32, the spatial illuminance controller 90 may send, to the second lighting device 12, a controller control signal to turn on the second lighting device 12 at a start brightness corresponding to a first illuminance measured by the first illumination sensor 21. The spatial illuminance controller 90 may also send, to the second lighting device 12, a controller control signal to increase the brightness of the second lighting device 12 to a target brightness lower than a maximum brightness of the second lighting device 12 (S112).

Here, the start brightness corresponding to the first illuminance means a brightness equal to or lower than the brightness corresponding to the first illuminance.

That is, upon receiving a turn-on signal from the first switch 31 (S102), the spatial illuminance controller sets a start brightness and a target brightness, based on the first illuminance measured in the first space SP1.

However, upon receiving a turn-on signal from the second switch 32 installed in the second space SP2 adjacent to the first space SP1 under the condition that the first lighting device 11 turns on (S110), the spatial illuminance controller 90 sets the start brightness and target brightness of the second lighting device 12, based on the first illuminance measured in the first space SP1.

The reason why the second lighting device 12 is driven as described above in accordance with the present invention is because, if the second lighting device 12 turns on at a brightness considerably higher than the brightness to generate the first illuminance when the user who has adapted to the first illuminance enters the second space SP2, the user may be uncomfortable.

For example, when the second lighting device 12 turns on at a brightness of 70% under the condition that the first illuminance is 50%, the eyes of the user may feel fatigued due to a higher illuminance than the first illuminance. In severe cases, the user may be uncomfortable.

On the other hand, when the second lighting device 12 turns on at a brightness of 10% considerably lower than 50% under the condition that the first illuminance is 50%, the user may be uncomfortable because a long time is taken for the second lighting device 12 to brighten to a target brightness.

Accordingly, in the present invention, when the first illuminance is 50%, the start brightness of the second lighting device 12 may be set to a brightness within a range of 31 to 50%, and the target brightness of the second lighting device 12 may be set to a brightness within a range of 51 to 60%.

Third, in accordance with the controller control signal, the lighting device 12 turns on at a start brightness within a range of 31 to 50%, and then generally increases the brightness thereof, to reach a target brightness within a range of 51 to 60%.

Finally, the method for controlling brightnesses of the lighting devices will be described in conjunction with the above-described fourth example. The method of the fourth example is a method for controlling brightness of the second lighting device 12 when the user desires to vary the target brightness under the condition that the second lighting device 12 generates the target brightness after turning on at the start brightness in accordance with the method of the first example. The method described in conjunction with the second example may be applied to the method of the fourth example in the same manner.

First, the user who is located in the second space SP2 raises or lowers a level of the second sub-switch 32b of the second switch 32. The second sub-switch 32b sends a lighting device control signal generated in accordance with the above-described operation to the spatial illuminance controller 90 (S114). In the following description, the present invention will be described in conjunction with an example in which the level of the second sub-switch 32b is raised, for convenience of description. The following description may also be applied to the case in which the level of the second sub-switch 32b is lowered.

Second, upon receiving a lighting device control signal to increase brightness of the second lighting device 12 from the second switch 32 under the condition that the second lighting device 12 is driven at the target brightness thereof, the spatial illuminance controller 90 sends, to the second lighting device 12, a controller control signal to control the second lighting device 12 to generate a controlled brightness higher than the target brightness of the second lighting device 12, but equal to or lower than the maximum brightness (S116).

Third, in accordance with the controller control signal, the second lighting device 12 gradually increases the brightness of the second lighting device 12 in order to enable the second lighting device 12 to reach the controlled brightness.

Thus, when the user turns on a lighting device, the above-described lighting device control system according to the present invention may control the lighting device to turn on at a start brightness to generate an illuminance equal to or lower than an ambient illuminance, and may then control the lighting device to generate a target brightness capable of generating an illuminance higher than the ambient illuminance and the illuminance corresponding to the start brightness.

Here, the ambient illuminance may be an illuminance of a space where the lighting device is installed or an illuminance of a space adjacent to the space where the lighting device is installed.

In addition, upon receiving a lighting device control signal to increase or decrease brightness of the lighting device under the condition that the lighting device is driven at the target brightness, the lighting device control system according to the present invention may control the lighting device to generate a controlled brightness corresponding to the lighting device control signal.

In brief, the present invention is applied to light adaptation indoor illumination and, as such, has an object to eliminate uncomfortableness caused by an abrupt increase in brightness occurring when the user moves from one place to another place.

That is, the present invention has an object to minimize eye fatigue and discomfort of the user by varying the start brightnesses and target brightnesses of lighting devices to various values in accordance with ambient illuminances.

### MODE FOR INVENTION

Various embodiments have been described in the best mode for carrying out the invention.

### INDUSTRIAL APPLICABILITY

Consequently, in the present invention, when the user moves from one space to another space, the lighting device installed in the latter space gradually brightens after turning on at a brightness corresponding to the illuminance of the former space, for light adaptation illumination.

Those skilled in the art to which the present invention pertains can appreciate that the invention may be embodied in other specific forms without changing the technical spirit or essential characteristics. Therefore, the embodiments described above should be understood as exemplary rather than limiting in all aspects. The scope of the present invention should also be interpreted by the claims below rather than the foregoing description. The meaning and range of the claims and all modifications as would he derived from the equivalent concept intended to be included within the scope of the present invention should also be interpreted as falling within the scope of the invention.

1. An indoor illumination control system comprising:
a first lighting device installed in a first space, to emit light;
a first switch for receiving a user control signal for control of brightness of the first lighting device;
a first illuminance sensor installed in the first space, to detect a first illuminance of the first space;
a second lighting device installed in a second space, to emit light;
a second switch for receiving a user control signal for control of brightness of the second lighting device;
a second illuminance sensor installed in the second space, to detect a second illuminance of the second space; and
a spatial illuminance controller storing a look-up table in which relations among illuminance, start brightness, and target brightness are set, and receiving the first illuminance and the second illuminance, the spatial illuminance controller sending, to the second lighting device, a controller control signal to turn on the second lighting device at a start brightness corresponding to the first illuminance while being stored in the look-up table, upon receiving a turn-on signal from the second switch in accordance with movement of an object from the first space to the second space, and sending, to the second lighting device, a controller control signal to increase a brightness of the second lighting device to a target brightness corresponding to the first illuminance while being stored in the look-up table,
wherein the controller control signal selects, as the start brightness, a brightness to generate an illuminance higher than a minimum illuminance that the second lighting device can generate, but equal to or lower than the first illuminance, and selects, as the target brightness, a brightness to generate an illuminance higher than the first illuminance, but equal to or lower than a maximum illuminance that the second lighting device can generate.

2. The indoor illumination control system according to claim 1, wherein:
the first switch comprises
a first main switch for turning on the first lighting device or sending a turn-on signal to the spatial illuminance controller, upon receiving the turn-on signal, while cutting off supply of electric power to the first lighting device upon receiving a turn-off signal, and
a first sub-switch for receiving a user control signal to increase or decrease a brightness of the first lighting device, and sending, to the spatial illuminance controller, a lighting device control signal corresponding to the user control signal;
the second switch comprises
a second main switch for turning on the second lighting device or sending a turn-on signal to the spatial illuminance controller, upon receiving the turn-on signal, while cutting off supply of electric power to the second lighting device upon receiving a turn-off signal, and
a second sub-switch for receiving a user control signal to increase or decrease the brightness of the second lighting device, and sending, to the spatial illuminance controller, a lighting device control signal corresponding to the user control signal received by the second sub-switch.

3. The indoor illumination control system according to claim 1, wherein the spatial illuminance controller sends, to the second lighting device, a controller control signal to control the second lighting device to generate a brightness higher than the target brightness, but lower than or equal to a maximum brightness of the second lighting device, upon receiving, from the second switch, a lighting device control signal to increase the brightness of the second lighting device.
